(19) United States
(12) Patent Application Publication
(10) Pub. No.: US 2025/0227583 A1
(43) Pub. Date: Jul. 10, 2025

(54) PRIMARY SECONDARY CELL CHANGE METHOD AND APPARATUS, AND COMPUTER-READABLE STORAGE MEDIUM

(71) Applicant: SPREADTRUM COMMUNICATIONS (SHANGHAI) CO., LTD., Shanghai (CN)

(72) Inventor: Yun DENG, Shanghai (CN)

(21) Appl. No.: 19/090,601

(22) Filed: Mar. 26, 2025

Related U.S. Application Data
(63) Continuation of application No. PCT/CN2023/121387, filed on Sep. 26, 2023.

(30) Foreign Application Priority Data
Sep. 30, 2022 (CN) 202211215175.5

(51) Int. Cl. H04W 36/08; H04W 36/00

(52) U.S. Cl. CPC H04W 36/08; H04W 36/00835

(57) ABSTRACT

A Primary Secondary Cell (PSCell) change method and apparatus, and a computer-readable storage medium are provided. The method includes: after parameters for consecutive Conditional PSCell Change (CPC) are configured, determining a target sk-counter parameter used in current execution of inter-Secondary Node (inter-SN) CPC; generating a first security parameter K_{SN} at least based on the target sk-counter parameter; and accessing a target PSCell at least based on the first security parameter K_{SN}.

### CROSS-REFERENCE TO RELATED APPLICATIONS

This application is a continuation under 35 U.S.C. § 120 of PCT/CN2023/121387, filed Sep. 26, 2023, which is incorporated herein by reference, and which claimed priority to Chinese Application No. 202211215175.5, filed Sep. 30, 2022. The present application likewise claims priority under 35 U.S.C. § 119 to Chinese Application No. 202211215175.5, filed Sep. 30, 2022, the entire content of which is also incorporated herein by reference.

### TECHNICAL FIELD

The present disclosure generally relates to radio communication technology field, and more particularly, to a Primary Secondary Cell (PSCell) change method and apparatus, and a computer readable storage medium.

### BACKGROUND

A conditional handover mechanism has been introduced in radio communication. Configuration of a candidate cell and a corresponding handover condition (conditional execution condition) are carried in reconfiguration signaling. For example, the handover condition may be signal quality of a candidate target cell being higher than signal quality of a current serving cell by a predetermined offset. After receiving the reconfiguration signaling, a User Equipment (UE) determines whether the handover condition of the candidate cell is met. If it is met, the UE uses configuration parameters of the candidate cell contained in the reconfiguration signaling to access the target cell, synchronize with the target cell, and initiate a random access procedure in the target cell, to implement a handover process.

The UE may establish a dual connectivity which can include different types. In radio communication scenarios, multiple different types of dual connectivity can be collectively referred to as Multi Radio Dual Connectivity (MR-DC). MR-DC includes E-UTRAN NR Dual Connectivity (EN-DC), NR E-UTRAN Dual Connectivity (NE-DC), NR NR Dual Connectivity (NR-DC), etc.

For the UE that has established the dual connectivity, a Secondary Node (SN) side may adopt the conditional handover mechanism. As a change of Secondary Cell Group (SCG) is not a handover in the strict sense, it is usually called Conditional PSCell Change (CPC).

In recent standard research, a method supporting consecutive CPC is proposed.

### SUMMARY

Embodiments of the present disclosure may improve security in a consecutive PSCell change process.

In an embodiment of the present disclosure, a PSCell change method is provided, including: obtaining a target sk-counter parameter used in current execution of CPC; generating a first security parameter K_{SN} at least based on the target sk-counter parameter; and accessing a target PSCell at least based on the first security parameter K_{SN}.

Optionally, said obtaining the target sk-counter parameter used in the current execution of CPC includes: obtaining a number of times inter-Secondary Node (inter-SN) CPC has been executed; and determining the target sk-counter parameter used in the current execution of CPC based on configuration information and the number of times inter-SN CPC has been executed, wherein the configuration information is used for configuring the sk-counter parameter.

Optionally, the configuration information configures a plurality of sk-counter parameters, and said determining the target sk-counter parameter used in the current execution of CPC based on the configuration information and the number of times inter-SN CPC has been executed includes: selecting a corresponding sk-counter parameter from the plurality of sk-counter parameters as the target sk-counter parameter based on the number of times inter-SN CPC has been executed.

Optionally, the configuration information configures one sk-counter parameter, and said determining the target sk-counter parameter used in the current execution of CPC based on the configuration information and the number of times inter-SN CPC has been executed includes: updating the sk-counter parameter for a corresponding number of times based on the number of times inter-SN CPC has been executed, and using an updated value of the sk-counter parameter as the target sk-counter parameter.

Optionally, when accessing the target PSCell, the method further includes: reporting a number of times of PSCell change associated with the first security parameter K_{SN} to the target PSCell.

Optionally, said accessing the target PSCell at least based on the first security parameter K_{SN} includes: updating the first security parameter K_{SN} based on the first security parameter K_{SN} and parameters of the target PSCell; and accessing the target PSCell based on the updated first security parameter K_{SN}.

In an embodiment of the present disclosure, a PSCell change method is provided, applied to a master node and including: determining that a UE has executed CPC; updating an sk-counter parameter, and updating a first security parameter K_{SN} using the updated sk-counter parameter and a second security parameter K_{MN}; and transmitting the updated first security parameter K_{SN} to a candidate PSCell configured for the UE.

Optionally, said determining that the UE has executed CPC includes: determining that the UE has executed inter-SN CPC.

In an embodiment of the present disclosure, a PSCell change method is provided, including: configuring a plurality of first security parameters K_{SN} for candidate PSCells, and configuring a plurality of sk-counter parameters for a User Equipment (UE), wherein the plurality of first security parameters K_{SN} have different values, and the plurality of sk-counter parameters and the plurality of first security parameters K_{SN} have one-to-one correspondence.

In an embodiment of the present disclosure, a PSCell change method is provided, including: receiving configuration information, wherein the configuration information includes a plurality of first security parameters K_{SN}, wherein the plurality of first security parameters K_{SN} are in one-to-one correspondence with a plurality of sk-counter parameters configured by a master node for a User Equipment (UE), and have different values; determining to serve as a target PSCell, traversing the plurality of first security parameters K_{SN}, and generating a plurality of integrity protection keys with one-to-one correspondence with the plurality of first security parameters K_{SN}; and verifying information sent by the UE using the plurality of integrity protection keys, and determining a target first security parameter K_{SN} from the plurality of first security parameters K_{SN}.

In an embodiment of the present disclosure, a candidate PSCell change apparatus is provided, including: a first changing circuitry, configured to change from a source PSCell to a target PSCell; and a first assessing circuitry, configured to assess candidate PSCells, wherein said assessing the candidate PSCells includes: assessing the candidate PSCells in response to a trigger condition being met; and/or, assessing a portion of the candidate PSCells.

In an embodiment of the present disclosure, a candidate PSCell change apparatus is provided, including: a second changing circuitry, configured to change from a source PSCell to a target PSCell; and a first processing circuitry, configured to delete configuration of candidate PSCells belonging to a source secondary node in response to the target PSCell and the source PSCell belong to different secondary nodes.

In an embodiment of the present disclosure, a PSCell change apparatus is provided, including: a first obtaining circuitry configured to obtain a target sk-counter parameter used in current execution of CPC; a first generating circuitry configured to generate a first security parameter K_{SN} at least based on the target sk-counter parameter; and a first accessing circuitry configured to access a target PSCell at least based on the first security parameter K_{SN}.

In an embodiment of the present disclosure, a PSCell change apparatus is provided, including: a first determining circuitry configured to determine that a UE has executed CPC; a third changing circuitry configured to: update an sk-counter parameter, and update a first security parameter K_{SN} using the updated sk-counter parameter and a second security parameter K_{MN}; and a first transmitting circuitry configured to transmit the updated first security parameter K_{SN} to a candidate PSCell configured for the UE.

In an embodiment of the present disclosure, a PSCell change apparatus is provided, including: a first configuring circuitry configured to: configure a plurality of first security parameters K_{SN} for candidate PSCells, and configure a plurality of sk-counter parameters for a UE, wherein the plurality of first security parameters K_{SN} have different values, and the plurality of sk-counter parameters are in one-to-one correspondence with the plurality of first security parameters K_{SN}.

In an embodiment of the present disclosure, a PSCell change apparatus is provided, including: a first receiving circuitry configured to receive configuration information, wherein the configuration information includes a plurality of first security parameters K_{SN}, wherein the plurality of first security parameters K_{SN} are in one-to-one correspondence with a plurality of sk-counter parameters configured by a master node for a UE, and have different values; a second generating circuitry configured to: determine to serve as a target PSCell, traverse the plurality of first security parameters K_{SN}, and generate a plurality of integrity protection keys with one-to-one correspondence with the plurality of first security parameters K_{SN}; and a second determining circuitry configured to: verify information sent by the UE using the plurality of integrity protection keys, and determine a target first security parameter K_{SN} from the plurality of first security parameters K_{SN}.

In an embodiment of the present disclosure, a non-volatile or non-transitory computer-readable storage medium having computer instructions stored therein is provided, wherein when the computer instructions are executed by a processor, any one of the above PSCell change methods is performed.

In an embodiment of the present disclosure, a PSCell change apparatus including a memory and a processor is provided, wherein the memory has computer instructions stored therein, and when the processor executes the computer instructions, any one of the above PSCell change methods is performed.

Embodiments of the present disclosure may provide following advantages.

When executing PSCell change, the target sk-counter parameter used in the current execution of CPC is obtained. The target sk-counter parameters used in different executions of CPC may be different. The first security parameter K_{SN} is generated at least based on the target sk-counter parameter, and then the target PSCell is accessed. In this manner, consecutive CPC is realized with guaranteed security.

### BRIEF DESCRIPTION OF THE DRAWINGS

FIG. 1 is a flow chart of a candidate PSCell change method according to an embodiment;

FIG. 2 is a flow chart of a candidate PSCell change method according to an embodiment;

FIG. 3 is a flow chart of a PSCell change method according to an embodiment;

FIG. 4 is a flow chart of a PSCell change method according to an embodiment;

FIG. 5 is a block diagram of a candidate PSCell change apparatus according to an embodiment;

FIG. 6 is a block diagram of a candidate PSCell change apparatus according to an embodiment;

FIG. 7 is a block diagram of a PSCell change apparatus according to an embodiment; and

FIG. 8 is a block diagram of a PSCell change apparatus according to an embodiment.

### DETAILED DESCRIPTION

As described in the background, in existing techniques, security during a consecutive CPC cannot be guaranteed.

In an embodiment of the present disclosure, when executing PSCell change, the target sk-counter parameter used in the current execution of CPC is obtained. The target sk-counter parameters used in different executions of CPC may be different. The first security parameter K_{SN} is generated at least based on the target sk-counter parameter, and then the target PSCell is accessed. In this manner, consecutive CPC is realized with guaranteed security.

In order to clarify the objects, characteristics and advantages of the disclosure, embodiments of present disclosure will be described in detail in conjunction with accompanying drawings.

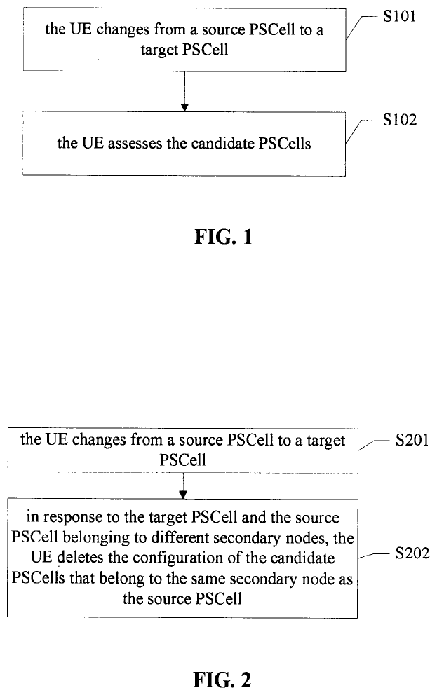

An embodiment of the present disclosure provides a PSCell change method. Referring to FIG. 1, detailed description is given below through specific steps.

In some embodiments, the candidate PSCell change method including S101 and S102 may be performed by a chip with a data processing function in a UE, or by a chip module containing a chip with a data processing function in a UE, or by a UE. The following takes the UE performing the candidate PSCell change method as an example for description.

In S101, the UE changes from a source PSCell to a target PSCell.

In some embodiments, a master node and/or a secondary node may configure measurement parameters for the UE. The UE performs corresponding measurement operations according to the measurement parameters configured by the master node and/or the secondary node. Specifically, specific content of the measurement parameters configured by the master node and/or the secondary node for the UE and a specific process of the UE performing the measurement operations may be referred to existing standards.

The UE acquires a measurement result obtained by the measurement operations, and reports the measurement result when a reporting condition is met. The master node and/or the secondary node determines to configure CPC for the UE based on capability information of the UE and a measurement report.

A process of configuring candidate PSCells by the master node is described below. The master node first selects a plurality of candidate PSCells, and then sends an SN addition request to secondary nodes to which the selected candidate PSCells belong, to request the secondary nodes to configure candidate SCGs. The master node may send SN addition requests to a plurality of secondary nodes, and then obtain request acknowledgements returned by the plurality of secondary nodes.

The master node obtains a plurality of candidate SCGs and sends the plurality of SCGs to the UE, each SCG containing a PSCell. The master node configures a corresponding PSCell change execution condition for each candidate PSCell. The PSCell change execution condition may include signal quality of the candidate PSCell being higher than that of a source PSCell by a preset offset. The PSCell change execution conditions corresponding to different candidate PSCells may be the same or different.

A process of configuring the candidate PSCells by the secondary node is described below. The secondary node may configure candidate PSCells belonging to the secondary node (which are called intra-SN candidate PSCells) for the UE, and directly send configuration of these candidate PSCells to the UE. Alternatively, the secondary node may configure candidate PSCells that do not belong to the secondary node (which are called inter-SN candidate PSCells) for the UE. In this case, the secondary node needs to send an SN addition request to other secondary nodes through the master node to request other secondary nodes to configure candidate SCGs. After any of the other secondary nodes returns configuration of candidate PSCells (included in the candidate SCGs) to the master node, the configuration is sent to the UE.

In some embodiments, when a network device (in embodiments of the present disclosure, the network device may include a master node and/or a secondary node unless otherwise specified) configures candidate PSCells for the UE, the UE is usually already at an edge of the source PSCell. After receiving a plurality of configured candidate PSCells, the UE may assess (can be also called ‘evaluate’) the plurality of candidate PSCells. In response to detecting that a candidate PSCell meets the PSCell change execution condition, the UE may change to the candidate PSCell. In this case, the candidate PSCell that meets the PSCell change execution condition may be referred to as a target PSCell.

In some embodiments, the source PSCell can be regarded as a PSCell that the UE accesses before the current PSCell change is executed, and a base station to which the source PSCell belongs is called a source secondary node. The plurality of candidate PSCells configured by the master node and/or the source secondary node for the UE are all neighboring cells of the source PSCell.

Specifically, specific implementation of the UE changing from the source PSCell to the target PSCell may be referred to the existing standards. Here, the UE executing the PSCell change may include executing CPC, or may be executing a PSCell change according to PSCell change signaling after receiving the signaling from a network device.

In S102, the UE assesses the candidate PSCells.

In some embodiments, said assessing the candidate PSCells includes: assessing the candidate PSCells in response to a trigger condition being met; or assessing a portion of the candidate PSCells; or assessing a portion of the candidate PSCells in response to a trigger condition being met.

In some embodiments, after the UE executes PSCell change, the configuration of the candidate PSCells configured by the network device (i.e., SCG configuration corresponding to the candidate PSCells) is retained. The candidate PSCells may include the source PSCell or may not include the source PSCell.

For example, in S101, if the PSCelle change signaling received from the network device includes a change execution condition related to the source PSCell, the UE may retain the configuration of the source PSCell and the change execution condition related to the source PSCell during the execution of PSCell change. Accordingly, the source PSCell becomes a candidate PSCell. If the UE executes CPC in S101, the configuration of the source PSCell is released during the execution of CPC, and thus the candidate PSCells do not include the source PSCell.

That is, the UE may determine, according to an instruction of the network device, whether to consider the source PSCell as a candidate PSCell after accessing the target PSCell.

After executing the PSCell change, the UE may continue to retain the configuration of the candidate PSCells. In a specific implementation, the UE may retain the configuration based on an explicit indication provided when the network device configures the candidate PSCells, where the explicit indication requires the UE to continue to retain the candidate PSCells after executing the PSCell change. It should be noted that in the embodiments of the present disclosure, the configuration of the candidate PSCells may include SCG configuration of the candidate PSCells and corresponding PSCell change execution conditions.

In some embodiments, after accessing the target PSCell, the UE may detect that signal quality of the target PSCell exceeds a preset threshold for a period of time. For example, the UE is in a low-speed motion state, and detects that the signal quality of the target PSCell continues to be high for a period of time after accessing the target PSCell. As the target PSCell can provide normal services to the UE for a period of time, the UE does not need to assess the candidate PSCells during the period of time.

In some embodiments, the preset threshold may be set according to a specific application scenario. Those skilled in the art could understand that the preset threshold needs to meet normal operation requirements of the UE. In other words, if the UE detects that the signal quality of the target PSCell is lower than or equal to the preset threshold, the target PSCell may not be able to provide services to the UE.

The signal quality of the target PSCell may be Reference Signal Receiving Power (RSRP) of the target PSCell, or Reference Signal Receiving Quality (RSRQ) of the target PSCell, or Signal to Interference plus Noise Ratio (SINR) of reference signal of the target PSCell.

In some embodiments, when the UE detects that the signal quality of the target PSCell is lower than or equal to a preset threshold, it is determined that the trigger condition is met and the candidate PSCells are assessed.

In some embodiments, after accessing the target PSCell, the UE continues to retain the configuration of the candidate PSCells. However, the UE may not need to immediately assess the candidate PSCells. In some embodiments, the UE starts assessment of the candidate PSCells only after receiving indication information sent by the master node or the secondary node, that is, after the master node or the secondary node explicitly instructs to assess the candidate PSCells.

In some embodiments, after the UE accesses the target PSCell, the master node or the secondary node may determine whether the UE is at the edge of the target PSCell based on a new measurement report acquired by the UE. In response to detecting that the UE is at the edge of the target PSCell, the master node or the secondary node generates indication information for triggering the UE to assess the candidate PSCells.

From above, the UE assesses the candidate PSCells only when the trigger condition is met, which effectively reduces the time for assessing the candidate PSCells and thus reduces power consumption of the UE.

In some embodiments, the candidate PSCells that the network device initially configures for the UE are all neighboring cells of the source PSCell. However, these candidate PSCells are not necessarily neighboring cells of the target PSCell that the UE newly accesses.

In some embodiments, when configuring the candidate PSCells for the UE through the configuration information, the master node may also indicate a second candidate PSCell in the configuration information. The second candidate PSCell may be a candidate PSCell that does not require assessment after the UE accessing the target PSCell.

When the UE assesses the candidate PSCells, the second candidate PSCell may be excluded, that is, the second candidate PSCell does not need to be assessed.

In some embodiments, the second candidate PSCell may include only one candidate PSCell, or may include two or more candidate PSCells.

From above, by excluding the second candidate PSCell, the number of the candidate PSCells that need to be assessed is reduced, and power consumption of the UE is reduced.

In some embodiments, the second candidate PSCell may be a non-neighboring cell of the target PSCell. In other words, the second candidate PSCell is not a neighboring cell of the target PSCell.

In some embodiments, the UE may assess the candidate PSCells except the second candidate PSCell when the signal quality of the target PSCell is lower than or equal to the preset threshold. Alternatively, the UE may start assessing the candidate PSCells only after receiving the indication information. That is, the embodiment of “assessing the candidate PSCells in response to the trigger condition being met” may be combined with the embodiment of “assessing the candidate PSCells except the second candidate PSCell”.

As it is unnecessary to assess the second candidate PSCell, the candidate PSCells except the second candidate PSCell are assessed in response to the triggering condition being met, which further reduces power consumption of the UE.

The PSCell change method provided in the above embodiments of the present disclosure is described in detail below via examples.

The master node configures six candidate PSCells for the UE, which are PSCell 1 to PSCell 6. PSCell 1 to PSCell 6 may be neighboring cells of the source PSCell currently camped.

After receiving the configuration of the candidate PSCells, the UE assesses the six PSCells. If any one of the candidate PSCells meets the PSCell change execution condition, the UE accesses the candidate PSCell that meets the condition. If detecting that PSCell 1 meets the PSCell change execution condition after assessment, the UE accesses PSCell 1, and retains PSCells 2 to PSCell 6.

One possible implementation method is as follows.

If the UE detects that signal quality of PSCell 1 exceeds the preset threshold within a period of time after accessing PSCell 1, the UE determines that the signal quality of PSCell 1 is relatively high and no CPC is required. During the period of time, the UE does not need to assess PSCell 2 to PSCell 6.

After another period of time, the UE detects that the signal quality of PSCell 1 is lower than or equal to the preset threshold, that is, the signal quality of PSCell 1 is relatively low. In this case, the UE may assess PSCell 2 to PSCell 6.

From above, when the signal quality of PSCell 1 is high, PSCell 2 to PSCell 6 are not assessed; and when the signal quality of PSCell 1 is low, PSCell 2 to PSCell 6 are assessed, which effectively reduces assessment time of the UE for PSCell 2 to PSCell 6 and reduces power consumption of the UE.

Another possible implementation method is as follows.

When configuring each of the six candidate PSCells for the UE, the master node indicates one or more other candidate PSCells that do not need to be assessed corresponding to each candidate PSCell, that is, instructs the UE not to assess the one or more other candidate PSCells after accessing a candidate PSCell.

After accessing PSCell 1, the UE determines, according to the instruction of the master node, that it is unnecessary to assess PSCell 2, and then only assesses PSCells 3 to PSCell 6.

From above, through the instruction of the master node, after executing CPC (accessing from the source PSCell to PSCell 1), the UE may only assess a portion of the candidate PSCells rather than all the candidate PSCells, thus, the number of assessments by the UE can be reduced and power consumption of the UE can be reduced.

Another possible implementation method is as follows.

After accessing PSCell 1, the UE does not immediately assess PSCell 2 to PSCell 6, but assesses PSCell 2 to PSCell 6 after receiving the instruction from the master node or the secondary node, that is, an explicit instruction for starting assessing the candidate PSCells.

From above, after executing CPC (accessing from the source PSCell to PSCell 1), the UE does not immediately assess the candidate PSCells, but waits for a period of time before assessing the candidate PSCells, thus, the number of assessments by the UE can also be reduced, and power consumption of the UE can be reduced.

Another possible implementation method is as follows.

When configuring each of the six candidate PSCells for the UE, the master node indicates one or more other candidate PSCells that do not need to be assessed corresponding to each candidate PSCell. The master node indicates as follows: if accessing PSCell 1, the UE does not need to assess PSCell 2.

If detecting that the signal quality of PSCell 1 exceeds the preset threshold within a period of time after accessing PSCell 1, the UE determines that the signal quality of PSCell 1 is relatively high and no CPC is required. During the period of time, the UE does not need to assess PSCell 2 to PSCell 6.

After another period of time, the UE detects that the signal quality of PSCell 1 is lower than or equal to the preset threshold. According to the instruction of the configuration information, the UE does not need to assess PSCell 2, and only needs to assess PSCell 3 to PSCell 6.

In the above embodiments of the present disclosure, the UE is set to retain all the candidate PSCells. As in the above examples, the master node configures 6 candidate PSCells for the UE, which are PSCell 1 to PSCell 6. The UE determines PSCell 1 as the target PSCell. After accessing PSCell 1, the UE retains the configuration of PSCell 2 to PSCell 6.

However, in fact, the UE may not need to assess some candidate PSCells. In the embodiment of the present disclosure, the UE may update all the candidate PSCells, delete the configuration of some candidate PSCells, and only assess the remaining candidate PSCells. As only some candidate PSCells need to be assessed, the power consumption of the UE is further reduced.

In some embodiments, secondary nodes to which the plurality of candidate PSCells configured by the master node and/or the secondary node belong may be the same or different. The secondary nodes to which the plurality of candidate PSCells belong may be the same as or different from a secondary node to which the source PSCell belongs.

In some embodiments, the plurality of candidate PSCells configured by the base station can be classified into two categories according to a relationship between the secondary nodes to which the candidate PSCells belong and the secondary node to which the source PSCell belongs. For the first category of candidate PSCell, the secondary node to which the candidate PSCell belongs is the same as the secondary node to which the source PSCell belongs (i.e., intra-SN candidate PSCell, the configuration of this category of PSCell is sent directly by the source secondary node to the UE). For the second category of PSCell, the secondary node to which the candidate PSCell belongs is different from the secondary node to which the source PSCell belongs (i.e., inter-SN candidate PSCell, the configuration of this category of PSCell is sent by the master node to the UE).

For example, the master node and/or the secondary node configures 6 candidate PSCells for the UE, which are PSCell 1 to PSCell 6 in turn. PSCell 1 to PSCell 6 may be neighboring cells of the source PSCell currently camped by the UE. The secondary node to which PSCell 1 to PSCell 3 belong is a source secondary node, and the secondary node to which PSCell 4 to PSCell 6 belong is a second secondary node that is different from the source secondary node. The secondary node to which the source PSCell belongs is the source secondary node. Accordingly, PSCell 1 to PSCell 3 are classified as the first category of candidate PSCells, and PSCell 4 to PSCell 6 are classified as the second category of candidate PSCells.

In some embodiments, the second category of candidate PSCells may be further classified into two types. One is inter-SN CPC triggered by the source secondary node, and the other is inter-SN CPC triggered by the master node.

In some embodiments, the first category of candidate PSCells are intra-SN candidate PSCells configured by the source secondary node for the UE. In this case, the first category of candidate PSCells do not contain security parameters of the secondary node side. When the UE accesses the first category of candidate PSCells, it is unnecessary to update a key on the secondary node side, and the UE can directly receive the configuration of the first category of candidate PSCells from the source secondary node.

The second category of candidate PSCells are candidate PSCells configured by a non-source secondary node for the UE. The configuration of the second category of candidate PSCells may be sent to the UE through the master node, and should include security parameters of the secondary node side, that is, a new K_{SN} needs to be generated when the UE accesses the second category of candidate PSCell.

In some embodiments, if the target PSCell accessed by the UE after executing the PSCell change belongs to the first category, the UE may continue to retain the configuration of the candidate PSCells, as the retained candidate PSCell continues to be valid when the UE executes CPC. If the target PSCell accessed belongs to the second category, the UE may delete the configuration of the first category of candidate PSCells and only retain the configuration of the second category of candidate PSCells, as the master node does not know that the first category of candidate PSCells were originally configured on the UE side, and will not reconfigure security parameters for these candidate PSCells. If the UE subsequently tries to access these candidate PSCells, access cannot be implemented without necessary security parameters, and thus the configuration of the first category of candidate PSCells needs to be deleted.

For example, the secondary node to which PSCell 1 to PSCell 3 belong is the source secondary node, and the secondary node to which PSCell 4 to PSCell 6 belong is the second secondary node that is different from the source secondary node. After the UE executes the PSCell change, the accessed PSCell 1 is the target PSCell, that is, the target PSCell belongs to the first category. In this case, the UE can retain the configuration of PSCell 2 to PSCell 6.

For another example, after the UE executes the PSCell change, the accessed PSCell 4 is the target PSCell, that is, the target PSCell belongs to the second category. In this case, the UE can delete the configuration of PSCell 1 to PSCell 3. That is, first remaining candidate PSCells include PSCell 5 and PSCell 6.

From above, the UE updates the configuration of retained candidate PSCells and deletes the configuration of some candidate PSCells. Consequently, the number of candidate PSCells that need to be assessed subsequently is effectively reduced, thereby reducing power consumption of the UE.

Continuing with the above example, after deleting the configuration of PSCell 1 to PSCell 3, the UE only needs to assess PSCell 5 and PSCell 6.

In some embodiments, after updating the candidate PSCells, the UE assesses the remaining candidate PSCells.

In response to the signal quality of the target PSCell being lower than or equal to the preset threshold, the UE may assess the remaining candidate PSCells.

For example, the target PSCell is PSCell 4 which belongs to the second category. The remaining candidate PSCells include PSCell 5 and PSCell 6. That is, PSCell 5 and PSCell 6 are the first remaining candidate PSCells.

When detecting that the signal quality of PSCell 4 is lower than or equal to the preset threshold, the UE assesses PSCell 5 and PSCell 6.

When configuring each of the candidate PSCells, the master node indicates one or more other candidate PSCells that do not need to be assessed when each candidate PSCell serves as the target PSCell. The candidate PSCells that do not need to be assessed are called second candidate PSCells. After accessing the target PSCell, the candidate PSCells that do not need to be accessed are removed from the remaining candidate PSCells to obtain newly updated candidate PSCells. The UE assesses the newly updated candidate PSCells.

For example, when the master node configures PSCell 4 as the target PSCell, there is no need to measure PSCell 5 (i.e., PSCell 5 is the second candidate PSCell, and is usually not a neighboring cell of PSCell 4). The target PSCell is PSCell 4 belonging to the second category. The remaining candidate PSCells include PSCell 5 and PSCell 6. After accessing PSCell 4, the UE updates the remaining candidate PSCells, and the candidate PSCell after the update is PSCell 6. Therefore, the UE assesses PSCell 6 to determine whether it meets the PSCell change execution condition. In this case, the master node and/or the secondary node may additionally configure a candidate PSCell for the UE.

In response to detecting that the signal quality of the target PSCell is lower than or equal to the preset threshold, the UE may assess the candidate PSCell after the new update.

Continuing with the above example, in response to detecting that the signal quality of PSCell 4 is lower than or equal to the preset threshold, the UE assesses PSCell 6.

Alternatively, in some embodiments, the UE may assess the candidate PSCell after update in response to receiving indication information.

For example, after receiving the indication information from the master node, the UE assesses the retained PSCell 5 and PSCell 6.

In the above embodiments, after executing the PSCell change, the UE determines whether to delete the first category of candidate PSCells based on whether the accessed target PSCell belongs to the source secondary node. That is, if the target PSCell belongs to the source secondary node, the UE retains the first category of candidate PSCells; otherwise, the UE deletes the first category of candidate PSCells.

The embodiments of the present disclosure may further have different implementation methods. After executing the PSCell change, if the accessed PSCell does not belong to the source secondary node, the UE continues to retain the first category of candidate PSCells, and the UE or the source secondary node indicates to the master node the number of the first category of candidate PSCells retained by the UE (optionally, the UE or the source secondary node may also indicate an identifier of the first category of candidate PSCells to the master node), so that the master node knows a total number of candidate PSCells retained on the UE side (the master node knows a number of the second category of candidate PSCells retained by the UE).

If other candidate PSCells are subsequently configured for the UE, the master node can control the total number of the candidate PSCells configured for the UE to avoid exceeding operation capability of the UE (e.g., supporting configuration of up to 8 candidate PSCells).

When learning that the UE has retained the first category of candidate PSCells, the master node needs to configure necessary security parameters for these candidate PSCells, so that encryption and integrity protection can be applied when the UE accesses these PSCells.

After learning that the UE has retained the first category of candidate PSCells, the master node may send security parameters to these PSCells, and inform the UE of the security parameters that need to be applied when accessing these PSCells.

Alternatively, the master node may uniformly configure security parameters for all candidate PSCells and send them to the UE in advance. The UE applies the corresponding security parameters when accessing these candidate PSCells, and further informs the accessed PSCell of associated information of the applied security parameters, so that the accessed PSCell can accurately derive an encryption key and an integrity protection key applied by the UE.

An embodiment of the present disclosure provides another PSCell change method. Referring to FIG. 2, detailed description is given below through specific steps.

In some embodiments, the candidate PSCell change method including S201 and S202 may be performed by a chip with a data processing function in a UE, or by a chip module containing a chip with a data processing function in a UE, or by a UE. The following takes the UE performing the candidate PSCell change method as an example for description.

In S201, the UE changes from a source PSCell to a target PSCell.

In some embodiments, the master node and/or the secondary node may configure measurement parameters for the UE. The UE performs corresponding measurement operations according to the measurement parameters configured by the master node and/or the secondary node. Specifically, specific content of the measurement parameters configured by the master node and/or the secondary node for the UE and a specific process of the UE performing the measurement operations may be referred to existing standards.

The UE acquires a measurement result obtained by the measurement operations, and reports the measurement result when a reporting condition is met. The master node and/or the secondary node determines to configure CPC for the UE based on capability information of the UE and a measurement report.

A process of configuring candidate PSCells by the master node is described below. The master node first selects a plurality of candidate PSCells, and then sends an SN addition request to secondary nodes to which the selected candidate PSCells belong, to request the secondary nodes to configure candidate SCGs. The master node may send SN addition requests to a plurality of secondary nodes, and then obtain request acknowledgements returned by the plurality of secondary nodes.

The master node obtains a plurality of candidate SCGs and sends the plurality of SCGs to the UE, each SCG containing a PSCell. The master node configures a corresponding PSCell change execution condition for each candidate PSCell. The PSCell change execution condition may include signal quality of the candidate PSCell being higher than that of a source PSCell by a preset offset. The PSCell change execution conditions corresponding to different candidate PSCells may be the same or different.

A process of configuring the candidate PSCells by the secondary node is described below. The secondary node may configure candidate PSCells belonging to the secondary node (which are called intra-SN candidate PSCells) for the UE, and directly send configuration of these candidate PSCells to the UE. Alternatively, the secondary node may configure candidate PSCells that do not belong to the secondary node (which are called inter-SN candidate PSCells) for the UE. In this case, the secondary node needs to send SN addition requests to other secondary nodes through the master node to request other secondary nodes to configure candidate SCGs. After any of the other secondary nodes returns configuration of candidate PSCells (included in the candidate SCGs) to the master node, the configuration is sent to the UE.

In some embodiments, when a network device configures candidate PSCells for the UE, the UE is usually already at an edge of the source PSCell. After receiving a plurality of configured candidate PSCells, the UE may assess the plurality of candidate PSCells. In response to detecting that a candidate PSCell meets the PSCell change execution condition, the UE may change to the candidate PSCell. In this case, the candidate PSCell that meets the PSCell change execution condition may be referred to as a target PSCell.

In some embodiments, the source PSCell can be regarded as a PSCell that the UE accesses before the current PSCell change is executed, and a base station to which the source PSCell belongs is called a source secondary node. The plurality of candidate PSCells configured by the master node and/or the source secondary node for the UE are all neighboring cells of the source PSCell.

In some embodiments, the master node may also directly instruct to access to the target PSCell, that is, send a PSCell change command. After obtaining the instruction from the master node, the UE changes from the source PSCell to the target PSCell.

Specifically, specific implementation of the UE changing from the source PSCell to the target PSCell may be referred to the existing standards.

In S202, in response to the target PSCell and the source PSCell belonging to different secondary nodes, the UE deletes the configuration of the candidate PSCells that belong to the same secondary node as the source PSCell.

In some embodiments, secondary nodes to which the plurality of candidate PSCells configured by the master node belong may be the same or different. The secondary nodes to which the plurality of candidate PSCells belong may be the same as or different from a secondary node to which the source PSCell belongs.

In some embodiments, the plurality of candidate PSCells configured by the base station can be classified into two categories according to a relationship between the secondary nodes to which the candidate PSCells belong and the secondary node to which the source PSCell belongs. For the first category of candidate PSCell, the secondary node to which the candidate PSCell belongs is the same as the secondary node to which the source PSCell belongs, or the configuration of this category of PSCell is sent directly by the source secondary node to the UE. For the second category of PSCell, the secondary node to which the candidate PSCell belongs is different from the secondary node to which the source PSCell belongs, or the configuration of this category of PSCell is sent by the master node to the UE.

For example, the master node configures 6 candidate PSCells for the UE, which are PSCell 1 to PSCell 6 in turn. PSCell 1 to PSCell 6 may be neighboring cells of the source PSCell currently camped by the UE. The secondary node to which PSCell 1 to PSCell 3 belong is a source secondary node, and the secondary node to which PSCell 4 to PSCell 6 belong is a second secondary node that is different from the source secondary node. The secondary node to which the source PSCell belongs is the source secondary node. Accordingly, PSCell 1 to PSCell 3 are classified as the first category of candidate PSCells, and PSCell 4 to PSCell 6 are classified as the second category of candidate PSCells.

In some embodiments, the second category of candidate PSCells may be further classified into two types. One is inter-SN CPC triggered by the source secondary node, and the other is inter-SN CPC triggered by the master node.

In some embodiments, the first category of candidate PSCells are intra-SN candidate PSCells configured by the source secondary node for the UE. In this case, the first category of candidate PSCells do not contain security parameters of the secondary node side. When the UE accesses the first category of candidate PSCells, it is unnecessary to update a key, and the UE can directly receive the configuration of the first category of candidate PSCells from the source secondary node.

The second category of candidate PSCells are candidate PSCells configured by a non-source secondary node for the UE. The configuration of the second category of candidate PSCells may be sent to the UE through the master node, and should include security parameters of the secondary node side, that is, a new K_{SN} needs to be generated when the UE accesses the second category of candidate PSCell.

In some embodiments, if the target PSCell belongs to the first category, the UE may continue to retain the configuration of the candidate PSCells. If the target PSCell belongs to the second category, the UE may delete the configuration of the first category of candidate PSCells and only retain the configuration of the second category of candidate PSCells.

For example, the secondary node to which PSCell 1 to PSCell 3 belong is the source secondary node, and the secondary node to which PSCell 4 to PSCell 6 belong is the second secondary node that is different from the source secondary node. When the UE accesses PSCell 1, the accessed PSCell 1 is the target PSCell. That is, the UE accesses the PSCell administered by the source secondary node. In this case, the UE can retain the configuration of PSCell 2 to PSCell 6.

For another example, when the UE accesses PSCell 4, the accessed PSCell 4 is the target PSCell. That is, the UE accesses a secondary node different from the source secondary node. In this case, the UE can delete the configuration of PSCell 1 to PSCell 3. That is, first remaining candidate PSCells include PSCell 5 and PSCell 6.

From above, the UE updates the configuration of retained candidate PSCells and deletes the configuration of some candidate PSCells. Consequently, the number of candidate PSCells that need to be assessed subsequently is effectively reduced, thereby reducing power consumption of the UE.

Continuing with the above example, after deleting the configuration of PSCell 1 to PSCell 3, the UE only needs to assess PSCell 5 and PSCell 6.

In some embodiments, after updating the candidate PSCells, the UE assesses the remaining candidate PSCells.

In response to the signal quality of the target PSCell being lower than or equal to the preset threshold, the UE may assess the remaining candidate PSCells.

For example, when the target PSCell is PSCell 4, the UE accesses a non-source secondary node. The remaining candidate PSCells include PSCell 5 and PSCell 6. That is, PSCell 5 and PSCell 6 are the first remaining candidate PSCells.

When detecting that the signal quality of PSCell 4 is lower than or equal to the preset threshold, the UE assesses PSCell 5 and PSCell 6.

When configuring each of the candidate PSCells, the master node indicates one or more other candidate PSCells that do not need to be assessed when each candidate PSCell serves as the target PSCell. The candidate PSCells that do not need to be assessed are called second candidate PSCells. After accessing the target PSCell, the candidate PSCells that do not need to be accessed are removed from the remaining candidate PSCells to obtain newly updated candidate PSCells. The UE assesses the newly updated candidate PSCells.

For example, when the master node configures PSCell 4 as the target PSCell, there is no need to measure PSCell 5 (i.e., PSCell 5 is the second candidate PSCell). The remaining candidate PSCells include PSCell 5 and PSCell 6. After accessing PSCell 4, the UE updates the remaining candidate PSCells, and the candidate PSCell after the update is PSCell 6. Therefore, the UE assesses PSCell 6 to determine whether it meets the PSCell change execution condition. In this case, the master node and/or the secondary node may additionally configure a candidate PSCell for the UE.

In response to detecting that the signal quality of the target PSCell is lower than or equal to the preset threshold, the UE may assess the candidate PSCell after the new update.

Continuing with the above example, in response to detecting that the signal quality of PSCell 4 is lower than or equal to the preset threshold, the UE assesses PSCell 6.

Alternatively, in some embodiments, the UE may assess the updated candidate PSCells in response to receiving indication information.

For example, after receiving the indication information from the master node, the UE assesses the retained PSCell 5 and PSCell 6.

In some embodiments, if the UE performs a master node handover, the UE releases the configuration of all the candidate PSCells.

From above, by updating the candidate PSCells and deleting the configuration of some candidate PSCells, the number of PSCells that need to be assessed is further reduced, and power consumption of the UE is further reduced.

In the above embodiments, after executing the PSCell change, the UE determines whether to delete the first category of candidate PSCells based on whether the accessed target PSCell belongs to the source secondary node. That is, if the target PSCell belongs to the source secondary node, the UE retains the first category of candidate PSCells; otherwise, the UE deletes the first category of candidate PSCells.

The embodiments of the present disclosure may further have different implementation methods. After executing the PSCell change, if the accessed PSCell does not belong to the source secondary node, the UE continues to retain the first category of candidate PSCells, and the UE or the source secondary node indicates to the master node the number of the first category of candidate PSCells retained by the UE (optionally, the UE or the source secondary node may also indicate an identifier of the first category of candidate PSCells to the master node), so that the master node knows a total number of candidate PSCells retained on the UE side (the master node knows a number of the second category of candidate PSCells retained by the UE).

If other candidate PSCells are subsequently configured for the UE, the master node can control the total number of the candidate PSCells configured for the UE to avoid exceeding operation capability of the UE (e.g., supporting configuration of up to 8 candidate PSCells).

When learning that the UE has retained the first category of candidate PSCells, the master node needs to configure necessary security parameters for these candidate PSCells, so that encryption and integrity protection can be applied when the UE accesses these PSCells.

After learning that the UE has retained the first category of candidate PSCells, the master node may send security parameters to these PSCells, and inform the UE of the security parameters that need to be applied when accessing these PSCells.

Alternatively, the master node may uniformly configure security parameters for all candidate PSCells and send them to the UE in advance. The UE applies the corresponding security parameters when accessing these candidate PSCells, and further informs the accessed PSCell of associated information of the applied security parameters, so that the accessed PSCell can accurately derive an encryption key and an integrity protection key applied by the UE.

FIG. 3 is a flow chart of a PSCell change method according to an embodiment. Referring to FIG. 3, detailed description is given below through specific steps.

In some embodiments, the PSCell change method including S301 to S303 may be performed by a chip with a data processing function in a UE, or by a chip module containing a chip with a data processing function in a UE, or by a UE. The following takes the UE performing the PSCell change method as an example for description.

In S301, the UE obtains a target sk-counter parameter used in current execution of CPC.

In some embodiments, a master node and/or a secondary node may configure measurement parameters for the UE. The UE performs corresponding measurement operations according to the measurement parameters configured by the master node and/or the secondary node. Specifically, specific content of the measurement parameters configured by the master node and/or the secondary node for the UE and a specific process of the UE performing the measurement operations may be referred to existing standards.

The UE acquires a measurement result obtained by the measurement operations, and reports the measurement result when a reporting condition is met. The master node and/or the secondary node determines to configure CPC for the UE based on capability information of the UE and a measurement report.

A process of configuring candidate PSCells by the master node is described below. The master node first selects a plurality of candidate PSCells, and then sends an SN addition request to secondary nodes to which the selected candidate PSCells belong, to request the secondary nodes to configure candidate SCGs. The master node may send SN addition requests to a plurality of secondary nodes, and then obtain request acknowledgements returned by the plurality of secondary nodes.

The master node obtains a plurality of candidate SCGs and sends the plurality of SCGs to the UE, each SCG containing a PSCell. The master node configures a corresponding PSCell change execution condition for each candidate PSCell. The PSCell change execution condition may include signal quality of the candidate PSCell being higher than that of a source PSCell by a preset offset. The PSCell change execution conditions corresponding to different candidate PSCells may be the same or different.

A process of configuring the candidate PSCells by the secondary node is described below. The secondary node may configure candidate PSCells belonging to the secondary node (which are called intra-SN candidate PSCells) for the UE, and directly send configuration of these candidate PSCells to the UE. Alternatively, the secondary node may configure candidate PSCells that do not belong to the secondary node (which are called inter-SN candidate PSCells) for the UE. In this case, the secondary node needs to send SN addition requests to other secondary nodes through the master node to request other secondary nodes to configure candidate SCGs. After any of the other secondary nodes returns configuration of candidate PSCells (included in the candidate SCGs) to the master node, the configuration is sent to the UE.

In some embodiments, when a network device (in embodiments of the present disclosure, the network device may include a master node and/or a secondary node unless otherwise specified) configures candidate PSCells for the UE, the UE is usually already at an edge of the source PSCell. After receiving a plurality of configured candidate PSCells, the UE may assess the plurality of candidate PSCells. In response to detecting that a candidate PSCell meets the PSCell change execution condition, the UE may change to the candidate PSCell. In this case, the candidate PSCell that meets the PSCell change execution condition may be referred to as a target PSCell.

In some embodiments, the source PSCell can be regarded as a PSCell that the UE accesses before the current PSCell change is executed. The plurality of candidate PSCells configured by the master node for the UE are all neighboring cells of the source PSCell.

Specifically, specific implementation of the UE changing from the source PSCell to the target PSCell may be referred to the existing standards. Here, the UE executing the PSCell change may include executing CPC, or may be executing a PSCell change according to PSCell change signaling after receiving the signaling from a network device.

In some embodiments, when configuring a plurality of candidate PSCells, the master node may configure a security parameter (sk-counter parameter) for each candidate PSCell, and a value of the sk-counter parameter may be 1 to 32. The master node may notify the UE of the sk-counter parameter, and notify a candidate secondary node (i.e., the secondary node to which the candidate PSCell belongs) of the first security parameter K_{SN} associated with the sk-counter parameter.

When accessing the target PSCell, the UE needs to know the target sk-counter parameter used in the current execution of CPC.

In the existing techniques, during one CPC process (a non-consecutive CPC process), the sk-counter configured by the master node for the UE is usually the same, that is, the same sk-counter is configured for different candidate PSCells. The reason lies in that after the UE performs one PSCell change, the configuration of other candidate PSCells is deleted.

In some embodiments, after the UE executes the PSCell change (CPC or PSCell change executed according to network instruction), the UE may continue to retain the configuration of the candidate PSCells. If the sk-counter contained in different PSCell quotas is the same, the UE may use the same first security parameter K_{SN} when accessing different PSCells multiple times subsequently, which is not conducive to security.

Therefore, different solutions need to be considered. One solution is to configure different sk-counter for different candidate PSCells, so that the UE can use different first security parameters K_{SN} when executing CPC multiple times subsequently. However, this may cause the sk-counter to be exhausted quickly, that is, the sk-counter needs to be flipped and started again from 0 or 1, which requires an update of a key of the UE on the master node side. Therefore, other implementation methods below are adopted in embodiments of the present disclosure.

In some embodiments, it is considered to adopt corresponding sk-counters for different times of CPC, that is, the value of sk-counter is associated with the number of CPC. In a process of multiple consecutive CPC, the sk-counter parameters corresponding to different times of CPC may be different. Therefore, it is necessary to determine the target sk-counter parameter used in the current execution of CPC.

In S302, the UE generates a first security parameter K_{SN} at least based on the target sk-counter parameter.

In S303, the UE accesses a target PSCell at least based on the first security parameter K_{SN}.

In some embodiments, when the UE accesses the target PSCell, the target sk-counter parameter is used to generate a security parameter applied on the secondary node side. Specifically, the first security parameter (such as K_{SN}) applied on the secondary node side is generated using a second security parameter K_{MN} on the master node side (such as K_{gNB} or K_{eNB}) and the target sk-counter parameter, and then a Radio Resource Control (RRC) key (encryption key) and an integrity protection key for the secondary node side are generated using the first security parameter K_{SN} to access the target PSCell. K_{SN} is also called S-K_{eNB} or S-K_{gNB}.

Specifically, a specific process of generating the RRC key and the integrity protection key by the UE to access the target PSCell can be referred to the existing techniques (TS33.501), which is not described in detail here.

In some embodiments, the master node may configure multiple sk-counter parameters for each candidate PSCell. The UE may apply multiple sk-counter parameters configured by the master node to multiple times of CPC to avoid using the same sk-counter for different times of CPC.

For example, the first sk-counter parameter is used for a first CPC (that is, the first time that the candidate PSCell appears to meet a PSCell change execution condition), and the second sk-counter parameter is used for a second CPC.

The UE detects for the first time that a candidate PSCell meets the PSCell change execution condition, and accesses the candidate PSCell (i.e., the target PSCell) that meets the PSCell change execution condition from the source PSCell. When first accessing the target, the UE uses the first sk-counter parameter of the configured multiple sk-counter parameters and the second security parameter (such as K_{gNB}) on the master node side to derive the first security parameter K_{SN} used for the first CPC, and then uses the first security parameter K_{SN} to derive the RRC key and the integrity protection key for the secondary node side. After accessing the target PSCell, the UE may feed back identification information of the target PSCell to the master node to inform the master node of the PSCell it is currently accessing.

After receiving the feedback from the UE, the master node may configure for the candidate PSCells with the first security parameter K_{SN} required for the UE to perform the second CPC. The first security parameter K_{SN} used in the second CPC is generated based on the second sk-counter parameter.

When executing the second CPC (i.e., executing CPC for the second time), the UE updates the first security parameter K_{SN} using the second sk-counter parameter among the configured multiple sk-counter parameters and the second security parameter K_{gNB} on the master node side.

That is, in the embodiments of the present disclosure, the first security parameter K_{SN} used in the first CPC is different from the first security parameter K_{SN} used in the second CPC.

The master node sends the first security parameter K_{SN} used in the second CPC to the candidate PSCells in advance. When the UE performs the second CPC, as the candidate PSCells have obtained the first security parameter K_{SN} used in the second CPC, the UE can successfully access the target PSCell determined by the second CPC.

For example, the master node configures 6 candidate PSCells for the UE, which are PSCell 1 to PSCell 6. PSCell 1 to PSCell 6 may be neighboring cells of the currently camped source PSCell. After receiving the configuration of the candidate PSCells, the UE assesses the six PSCells. If detecting that PSCell 1 meets the PSCell change execution condition after assessment, the UE accesses PSCell 1, and retains PSCell 2 to PSCell 6. The master node configures 10 sk-counter parameters for the UE with values of 1, 2, 3, 4, 5, 6, 7, 8, 9 and 10, respectively.

In the above examples, the sk-counter parameters configured by the master node are consecutive. It is understandable that the sk-counter configured by the master node may be inconsecutive.

The UE changes from the source PSCell to PSCell 1 (the first CPC). The UE generates the first security parameter K_{SN} based on the first sk-counter parameter (a value of the sk-counter parameter is 1) and the second security parameter (K_{gNB}) on the master node side.

The UE notifies the master node that it has accessed PSCell 1. After learning that the UE has accessed PSCell 1, the master node generates the first security parameter K_{SN} based on the second sk-counter parameter (a value of the sk-counter parameter value is 2) and the second security parameter (K_{gNB}) on the master node side. Afterward, the newly generated first security parameter K_{SN} is sent to other candidate PSCells.

The UE continues to assess the candidate PSCells. If detecting that PSCell 2 meets the PSCell change execution condition, the UE accesses PSCell 2, and retains PSCell 1 and PSCell 3 to PSCell 6.

The UE changes from PSCell 1 to PSCell 2 (the second CPC). The UE derives a new first security parameter K_{SN} based on the second sk-counter parameter (a value of the sk-counter parameter is 2) and the second security parameter (K_{gNB}) on the master node side.

From above, the first security parameter K_{SN} generated by the master node after learning that the UE has accessed PSCell 1 is different from the first security parameter K_{SN} generated by the UE for the first time, and is the same as the first security parameter K_{SN} generated by the UE for the second time.

The UE notifies the master node that it has accessed PSCell 2. After learning that the UE has accessed PSCell 2, the master node updates the first security parameter K_{SN} based on the third sk-counter parameter (a value of the sk-counter parameter is 3) and the second security parameter (K_{gNB}) on the master node side. Afterward, the new first security parameter K_{SN} is sent to other candidate PSCells.

The UE changes from PSCell 2 to PSCell 3 (a third CPC). The UE updates the first security parameter K_{SN} based on the third sk-counter parameter (a value of the sk-counter parameter is 3) and the second security parameter (K_{gNB}) on the master node side.

In this manner, the update of the security parameter during multiple consecutive CPC is achieved.

Alternatively, in some embodiments, the master node may configure only one sk-counter parameter. At each CPC, the UE updates the sk-counter parameter used last time, and uses the updated sk-counter parameter to update the first security parameter K_{SN}. Accordingly, after receiving identification information of the target PSCell fed back by the UE, the master node updates the sk-counter parameter according to the same update rule, and uses the updated sk-counter parameter to generate the corresponding first security parameter K_{SN}, and sends it to the candidate PSCells.

For example, the master node configures 6 candidate PSCells for the UE, which are PSCell 1 to PSCell 6. After receiving the configuration of the candidate PSCells, the UE assesses the six PSCells. If detecting that PSCell 1 meets the PSCell change execution condition after assessment, the UE accesses PSCell 1, and retains PSCell 2 to PSCell 6. The master node configures 1 sk-counter parameter for the UE with an initial value of 1.

The UE changes from the source PSCell to PSCell 1 (the first CPC). The UE generates the first security parameter K_{SN} based on the sk-counter parameter (a value of the sk-counter parameter is 1) and the second security parameter (K_{gNB}) on the master node side.

The UE notifies the master node that it has accessed PSCell 1. After learning that the UE has accessed PSCell 1, the master node updates the sk-counter parameter, and the value of the updated sk-counter parameter is 2. The master node generates the first security parameter K_{SN} based on the updated sk-counter parameter (with a value of 2) and the second security parameter (K_{gNB}) on the master node side. The master node sends the new first security parameter K_{SN} to the candidate PSCells.

The UE continues to assess the candidate PSCells. If detecting that PSCell 2 meets the PSCell change execution condition, the UE accesses PSCell 2, and retains PSCell 1 and PSCell 3 to PSCell 6.

The UE changes from PSCell 1 to PSCell 2 (the second CPC). The UE updates the sk-counter parameter, and the value of the updated sk-counter parameter is 2. The UE updates the first security parameter K_{SN} based on the updated sk-counter parameter (with a value of 2) and the second security parameter (K_{gNB}, which can also be denoted by K_{MN}) on the master node side. The UE uses the new first security parameter K_{SN} to derive the RRC key and the integrity protection key to access PSCell 2.

The UE notifies the master node that it has accessed PSCell 2. After learning that the UE has accessed PSCell 2, the master node continues to update the sk-counter parameter, and the updated sk-counter parameter takes a value of 3. The master node updates the first security parameter K_{SN} based on the updated sk-counter parameter (with a value of 3) and the second security parameter (K_{gNB}) on the master node side. The master node sends the new first security parameter K_{SN} to the candidate PSCells.

In this manner, the update of the safety parameter during multiple consecutive CPC is achieved.

In the above embodiments, the master node needs to frequently send the updated first security parameter K_{SN} to the candidate PSCells, resulting in a large interface signaling overhead between base stations.

To reduce the interface signaling overhead, the master node may indicate multiple available first security parameters K_{SN} to the candidate PSCells when configuring the parameters of CPC. Accordingly, the master node may configure the sk-counter parameter for CPC, and each sk-counter parameter has a corresponding first security parameter K_{SN}. The master node may send multiple first security parameters K_{SN} corresponding to multiple sk-counter respectively to the secondary node when requesting the secondary node to configure the candidate PSCells, so that the PSCell has the corresponding security parameter when the UE accesses the PSCell.

When executing the first CPC, the UE uses the first sk-counter parameter to generate the first security parameter K_{SN}. When executing the second CPC, the UE uses the second sk-counter parameter to update the first security parameter K_{SN}, and so on.

However, in a particular CPC, the target PSCell does not actually know how many times the UE has executed CPC. A specific reason is explained in the following embodiment. Therefore, the target PSCell may traverse all the first security parameters K_{SN}, derive the corresponding RRC key and integrity protection key on the secondary node side, and use the integrity protection key to verify data/signaling sent by the UE. If the verification is successful, it means that a correct first security parameter K_{SN} is selected, and the correct first security parameter K_{SN} is used.

The embodiments of the present disclosure may have different implementation methods. When the UE accesses a particular PSCell, the corresponding sk-counter is applied to derive the first security parameter K_{SN} for this access. To make the target PSCell to which the UE accesses know how many times CPC has been executed by the UE, the UE may report a number of PSCell changes associated with the first security parameter K_{SN} when accessing the PSCell. For example, the UE may indicate the number of PSCell changes through a layer 2 media access layer, so that the target PSCell may determine the corresponding first security parameter K_{SN} based on the number of PSCell changes.

The UE may indicate the number of PSCell changes to the target PSCell during a random access process of accessing the target PSCell, such as carrying the number of PSCell changes in a third random access message. The number of PSCell changes may refer to the number of PSCell changes that have been executed (excluding the current PSCell change), or may refer to the number of PSCell changes including the current PSCell change, or may refer to the number of inter-SN PSCell changes that have been executed, or may refer to the number of inter-SN PSCell changes including the current PSCell change. Alternatively, the number of PSCell changes may be sent in advance by the master node to the candidate PSCells (including the target PSCell).

In some embodiments, secondary nodes to which the plurality of candidate PSCells configured by the master node belong may be the same or different. The secondary nodes to which the plurality of candidate PSCells belong may be the same as or different from a secondary node to which the source PSCell belongs.

In some embodiments, the plurality of candidate PSCells configured by the base station can be classified into two categories according to a relationship between the secondary nodes to which the candidate PSCells belong and the secondary node to which the source PSCell belongs. For the first category of candidate PSCell, the secondary node to which the candidate PSCell belongs is the same as the secondary node to which the source PSCell belongs. For the second category of PSCell, the secondary node to which the candidate PSCell belongs is different from the secondary node to which the source PSCell belongs.

For example, the master node configures 6 candidate PSCells for the UE, which are PSCell 1 to PSCell 6 in turn. PSCell 1 to PSCell 6 may be neighboring cells of the source PSCell currently camped by the UE. The secondary node to which PSCell 1 to PSCell 3 belong is a source secondary node, and the secondary node to which PSCell 4 to PSCell 6 belong is a second secondary node that is different from the source secondary node. The secondary node to which the source PSCell belongs is the source secondary node. Accordingly, PSCell 1 to PSCell 3 are classified as the first category of candidate PSCells, and PSCell 4 to PSCell 6 are classified as the second category of candidate PSCells.

In some embodiments, the second category of candidate PSCells may be further classified into two types. One is inter-SN CPC triggered by the source secondary node, and the other is inter-SN CPC triggered by the master node.

In some embodiments, the first category of candidate PSCells are intra-SN candidate PSCells configured by the source secondary node for the UE. In this case, the first category of candidate PSCells do not contain security parameters of the secondary node side. When the UE accesses the first category of candidate PSCells, it is unnecessary to update a key, and the UE can directly receive the configuration of the first category of candidate PSCells from the source secondary node.

The second category of candidate PSCells are candidate PSCells configured by a non-source secondary node for the UE. The configuration of the second category of candidate PSCells may be sent to the UE through the master node, and should include security parameters of the secondary node side, that is, a new K_{SN} needs to be generated when the UE accesses the second category of candidate PSCells.

Therefore, in the embodiments of the present disclosure, if the source PSCell and the target PSCell belong to a same secondary node during a particular CPC executed by the UE, the first security parameter K_{SN} corresponding to the same secondary node is the same, and thus the UE does not need to update the sk-counter parameter. In this case, the UE does not need to feed back the identification information of the target PSCell to the master node. In each PSCell change, the PSCell currently accessed by the UE is the source PSCell, and the newly accessed PSCell is the target PSCell.

In other words, in the embodiments of the present disclosure, in a scenario where the UE updates the sk-counter parameter during execution of a CPC, the source PSCell corresponding to this CPC and the target PSCell belong to different secondary nodes.

That is, obtaining the target sk-counter parameter used in the current execution of CPC may include: obtaining the number of times CPC between the secondary nodes has been executed; and determining the target sk-counter parameter used in the current execution of CPC based on the configuration information and the number of times CPC between the secondary nodes has been executed, where the configuration information is used to configure the sk-counter parameter.

Specifically, if the configuration information configures multiple sk-counter parameters, a corresponding sk-counter parameter may be selected from the multiple sk-counter parameters as the target sk-counter parameter based on the number of times CPC between the secondary nodes has been executed. If the configuration information configures one sk-counter parameter, the sk-counter parameter is updated for a corresponding number of times (e.g., ‘1’ or ‘2’ is added each time) based on the number of times CPC between the secondary nodes has been executed, and the updated value obtained is used as the target sk-counter parameter.

For example, the UE executes the first CPC to change from the source PSCell to PSCell 1. The source PSCell belongs to the secondary node 1, and PSCell 1 belongs to the secondary node 2. The UE generates the first security parameter K_{SN} based on the first sk-counter parameter (with a value of 1) and the second security parameter (K_{gNB}) on the master node side.

The UE notifies the master node that it has accessed PSCell 1. After learning that the UE has accessed PSCell 1, the master node generates the first security parameter K_{SN} based on the second sk-counter parameter (with a value of 2) and the second security parameter (K_{gNB}) on the master node side. The master node sends the newly generated first security parameter K_{SN} to the candidate PSCells through an interface between base stations.

The UE continues to assess the candidate PSCells. If detecting that PSCell 2 meets the PSCell change execution condition after assessment, the UE accesses PSCell 2, and retains PSCell 1 and PSCell 3 to PSCell 6.

The UE changes from PSCell 1 to PSCell 2 (the second CPC). The UE updates the first security parameter K_{SN} based on the second sk-counter parameter (with a value of 2) and the second security parameter (K_{gNB}) on the master node side.

In the second CPC, the source PSCell is PSCell 1, and the target PSCell is PSCell 2. If PSCell 2 belongs to the secondary node 2, the UE does not inform the master node to access PSCell 2. Therefore, the master node does not need to update the first security parameter K_{SN}.

In the above embodiment, the UE generates the first security parameter K_{SN} based on the sk-counter parameter and the second security parameter (K_{MN}) on the master node side. For multiple consecutive CPC, some candidate PSCells are always retained on the UE side. In this case, for a non-first PSCell change, such as the second or third CPC, the first security parameter K_{SN} can be derived in a new manner.

For example, the first security parameter K_{SN} is derived using the first security parameter K_{SN} in the first CPC and parameters of the target PSCell to which the UE accesses (such as downlink frequency and/or other parameters such as a physical cell identifier, etc.). During the execution of the second CPC, a new first security parameter K_{SN} is derived based on the first security parameter K_{SN} in the first CPC (it is assumed that Counter in configuration of the target PSCell in the second CPC has a same value as the Counter in the configuration of the target PSCell in the first CPC) and parameters of the target PSCell currently accessed by the UE (such as the downlink frequency and/or other parameters such as the physical cell identifier, etc.). When the UE performs the third CPC, a new first security parameter K_{SN} is derived based on the K_{SN} in the first CPC (it is assumed that the Counter in the configuration of the target PSCell in the third CPC is the same as the Counter in the configuration of the target PSCell in the first CPC) and the parameters of the target PSCell currently accessed by the UE (such as the downlink frequency and/or other parameters such as the physical cell identifier, etc.).

As the candidate PSCells have the first security parameter K_{SN} provided by the master node for the first CPC, update on key for the subsequent CPC can be implemented without modifying an interface between the existing base stations. For the UE, the sk-counter corresponding to the first CPC can be obtained from the configuration of the candidate PSCells (the configuration of the candidate PSCells only needs to include one sk-counter), and then generates the first security parameter K_{SN} used for the first CPC (that is, a key derivation mechanism for the first CPC remains unchanged) based on the second security parameter (K_{MN}) on the master node side and the sk-counter (i.e., the sk-counter corresponding to the first CPC). Afterward, in the subsequent CPC, a new first security parameter K_{SN} is derived based on the first security parameter K_{SN} used for the first CPC and the parameters of the target PSCell currently accessed by the UE (such as the downlink frequency and/or other parameters such as the physical cell identity, etc.). That is, for a non-first CPC scenario, the new first security parameter K_{SN} derivation mechanism is adopted, and a source K_{SN} required for each derivation is the first security parameter K_{SN} obtained in the first CPC. This implementation method modifies the existing first security parameter K_{SN} derivation mechanism for non-first CPC, and well follows the existing first security parameter K_{SN} derivation mechanism for the first CPC (that is, the K_{SN} derivation mechanism remains unchanged in the first CPC).

One improvement lies in following aspect. For a scenario where the configuration of the candidate PSCells needs to be retained after a (conditional) PSCell change occurs, the UE adopts the new K_{SN} derivation mechanism in the subsequent CPC process, which also includes the first CPC scenario. In this case, when executing CPC, the UE generates the first security parameter K_{SN} based on the sk-counter parameter (at this time, there is only one sk-counter value) included in the configuration of the accessed target PSCell and the second security parameter (K_{MN}) on the master node side, derives a new first security parameter K_{SN} based on that K_{SN} and the parameters of the accessed target PSCell (such as downlink frequency and/or other parameters such as physical cell identity, etc.), and accesses the target PSCell based on the new first security parameter K_{SN}. That is, the RRC key and the integrity protection key are derived using the new first security parameter K_{SN}, and the keys are applied when accessing the target PSCell.

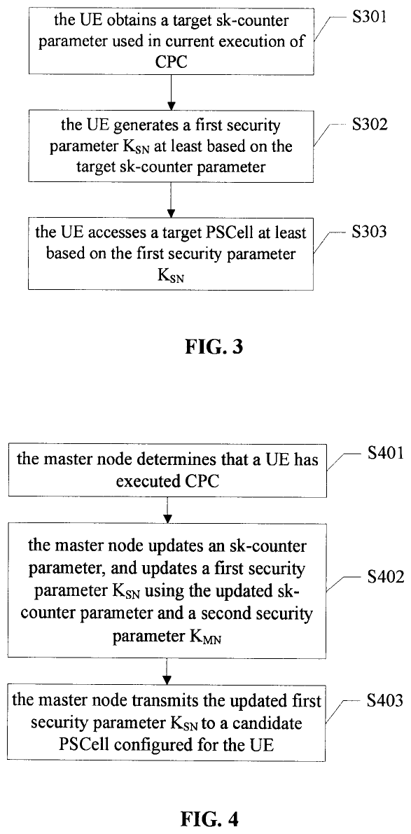

FIG. 4 is a flow chart of another PSCell change method according to an embodiment. Referring to FIG. 4, detailed description is given below through specific steps.

In some embodiments, the PSCell change method including S401 to S403 may be performed by a chip with a data processing function in an access network device (e.g., a master node), or by a chip module containing a chip with a data processing function in an access network device (e.g., a master node), or by an access network device (e.g., a master node). The following takes the master node performing the PSCell change method as an example for description.

In S401, the master node determines that a UE has executed CPC.

In S402, the master node updates an sk-counter parameter, and updates a first security parameter K_{SN} using the updated sk-counter parameter and a second security parameter K_{MN}.

In S403, the master node transmits the updated first security parameter K_{SN} to a candidate PSCell configured for the UE.

In some embodiments, a specific execution process of S401 to S403 may be referred to S301 to S303, which is not repeated here.

An embodiment of the present disclosure further provides another PSCell change method, which is performed by an access network device (e.g., a master node).

The master node may indicate multiple available first security parameters K_{SN} to the candidate PSCells when configuring the parameters of CPC. Accordingly, the master node may configure the sk-counter parameter for CPC, and each sk-counter parameter has a corresponding first security parameter K_{SN}. The master node may indicate multiple available K_{SN} in an SN addition request.

When executing the first CPC, the UE uses the first sk-counter parameter to generate the first security parameter K_{SN}. When executing the second CPC, the UE uses the second sk-counter parameter to update the first security parameter K_{SN}, and so on.

However, in a particular CPC, the target PSCell does not actually know how many times the UE has executed CPC. A specific reason can be referred to the above embodiments. Therefore, the target PSCell may traverse all the first security parameters K_{SN}, derive the corresponding RRC key and integrity protection key on the secondary node side, and use the integrity protection key to verify data/signaling sent by the UE. If the verification is successful, it means that a correct first security parameter K_{SN} is selected, and the correct first security parameter K_{SN} is used.

An embodiment of the present disclosure further provides another PSCell change method, which may be executed by a target PSCell. When configuring a plurality of candidate PSCells, a master node can configure a plurality of sk-counter parameters for CPC in configuration information, and each sk-counter parameter has a corresponding first security parameter K_{SN}.

When a candidate PSCell serves as the target PSCell, the target PSCell does not actually know how many times the UE has executed CPC. A specific reason can be referred to the above embodiments. Therefore, the target PSCell may traverse all the first security parameters K_{SN}, derive the corresponding RRC key and integrity protection key on the secondary node side, and use the integrity protection key to verify data/signaling sent by the UE. If the verification is successful, it means that a correct first security parameter K_{SN} is selected, and the correct first security parameter K_{SN} is used.

In this manner, the update of security parameters during consecutive CPC can be achieved.

FIG. 5 is a block diagram of a candidate PSCell change apparatus 50 according to an embodiment. The candidate PSCell change apparatus 50 includes a first changing circuitry 501 and a first assessing circuitry 502.

The first changing circuitry 501 is configured to change from a source PSCell to a target PSCell.

The first assessing circuitry 502 is configured to assess candidate PSCells, wherein said assessing the candidate PSCells includes: assessing the candidate PSCells in response to a trigger condition being met; and/or, assessing a portion of the candidate PSCells.

In some embodiments, a specific execution process of the first changing circuitry 501 and the first assessing circuitry 502 may correspond to S101 and S102, which is not described in detail here.

In some embodiments, the candidate PSCell change apparatus 50 may correspond to a chip with a data processing function in a UE, such as a baseband chip, or to a chip module containing a chip with a data processing function in a UE, or to a UE.

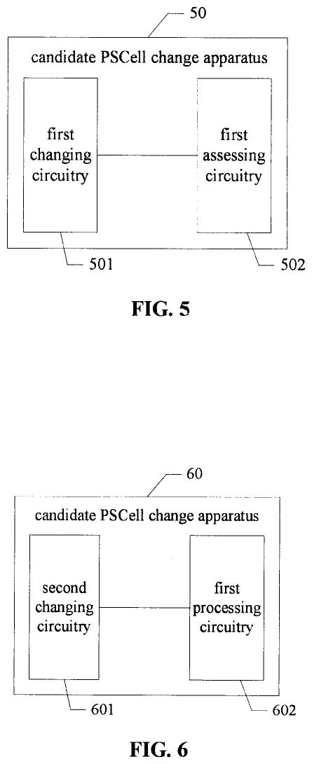

FIG. 6 is a block diagram of another candidate PSCell change apparatus 60 according to an embodiment. The candidate PSCell change apparatus 60 includes a second changing circuitry 601 and a first processing circuitry 602.

The second changing circuitry 601 is configured to change from a source PSCell to a target PSCell.

The first processing circuitry 602 is configured to delete configuration of candidate PSCells belonging to a source secondary node in response to the target PSCell and the source PSCell belong to different secondary nodes.

In some embodiments, a specific execution process of the second changing circuitry 601 and the first processing circuitry 602 may correspond to S201 and S202, which is not described in detail here.

In some embodiments, the candidate PSCell change apparatus 60 may correspond to a chip with a data processing function in a UE, such as a baseband chip, or to a chip module containing a chip with a data processing function in a UE, or to a UE.

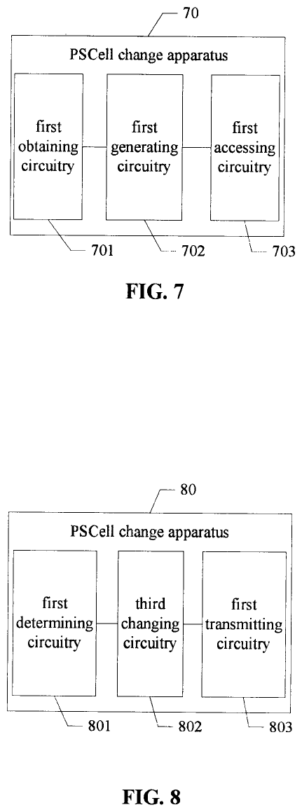

FIG. 7 is a block diagram of a PSCell change apparatus 70 according to an embodiment. The PSCell change apparatus 70 includes a first obtaining circuitry 701, a first generating circuitry 702 and a first accessing circuitry 703.

The first obtaining circuitry 701 is configured to obtain a target sk-counter parameter used in current execution of CPC.

The first generating circuitry 702 is configured to generate a first security parameter K_{SN} at least based on the target sk-counter parameter.

The first accessing circuitry 703 is configured to access a target PSCell at least based on the first security parameter K_{SN}.

In some embodiments, a specific execution process of the first obtaining circuitry 701, the first generating circuitry 702 and the first accessing circuitry 703 may correspond to S301 to S303, which is not described in detail here.

In some embodiments, the PSCell change apparatus 70 may correspond to a chip with a data processing function in an access network device (e.g., a master node), such as a baseband chip, or to a chip module containing a chip with a data processing function in an access network device, or to an access network device.

FIG. 8 is a block diagram of another PSCell change apparatus 80 according to an embodiment. The PSCell change apparatus 80 includes a first determining circuitry 801, a third changing circuitry 802 and a first transmitting circuitry 803.

The first determining circuitry 801 is configured to determine that a UE has executed CPC.

The third changing circuitry 802 is configured to: update an sk-counter parameter, and update a first security parameter K_{SN} using the updated sk-counter parameter and a second security parameter K_{MN}.

The first transmitting circuitry 803 is configured to transmit the updated first security parameter K_{SN} to a candidate PSCell configured for the UE.

In some embodiments, a specific execution process of the first determining circuitry 801, the third changing circuitry 802 and the first transmitting circuitry 803 may correspond to S401 to S403, which is not described in detail here.

In some embodiments, the PSCell change apparatus 80 may correspond to a chip with a data processing function in an access network device (e.g., a master node), such as a baseband chip, or to a chip module containing a chip with a data processing function in an access network device, or to an access network device.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer readable storage medium having computer instructions stored therein is provided, wherein when the computer instructions are executed by a processor, the candidate PSCell change method including S101 and S102, or the candidate PSCell change method including S201 and S202, or the PSCell change method provided in any one of the above embodiments is performed.

In an embodiment of the present disclosure, a candidate PSCell change apparatus including a memory and a processor is provided, wherein the memory has computer instructions stored therein, and when the processor executes the computer instructions, the candidate PSCell change method provided in any one of the above embodiments is performed.

In an embodiment of the present disclosure, a PSCell change apparatus including a memory and a processor is provided, wherein the memory has computer instructions stored therein, and when the processor executes the computer instructions, the PSCell change method provided in any one of the above embodiments is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A Primary Secondary Cell (PSCell) change method, comprising:
after parameters for consecutive Conditional PSCell Change (CPC) are configured, determining a target sk-counter parameter used in current execution of inter-Secondary Node (inter-SN) CPC;
generating a first security parameter K_{SN} at least based on the target sk-counter parameter; and
accessing a target PSCell at least based on the first security parameter K_{SN}.

2. The method according to claim 1, wherein said determining the target sk-counter parameter used in the current execution of inter-SN CPC comprises:
selecting a first unused sk-counter among a plurality of sk-counter parameters included in the configured parameters as the target sk-counter parameter used in the current execution of inter-SN CPC.

3. The method according to claim 1, wherein the configured parameters comprise a plurality of sk-counter parameters corresponding to the target PSCell.

4. The method according to claim 1, wherein following accessing the target PSCell, the method further comprises:
retaining configuration of candidate PSCells other than the target PSCell.

5. The method according to claim 1, wherein when accessing the target PSCell, the method further comprises:
reporting a number associated with the first security parameter K_{SN}.

6. The method according to claim 1, wherein said accessing the target PSCell at least based on the first security parameter K_{SN} comprises:
deriving a security parameter based on the first security parameter K_{SN}; and
accessing the target PSCell based on the derived security parameter.

7. A Primary Secondary Cell (PSCell) change method, applied to a master node and comprising:
during a process of configuring consecutive Conditional PSCell Change (CPC) for a User Equipment (UE), sending a plurality of first security parameters K_{SN} to at least one Secondary Node (SN), wherein the plurality of first security parameters K_{SN} are in one-to-one correspondence with a plurality of sk-counter parameters.

8. The method according to claim 7, further comprising:
receiving a response from the at least one secondary node, wherein the response comprises parameters for consecutive CPC; and
sending CPC parameters to the UE, wherein the CPC parameters comprise the plurality of sk-counter parameters which are to be used by the UE when executing inter-SN CPC.

9. A Primary Secondary Cell (PSCell) change apparatus, comprising a memory and a processor, wherein the memory stores one or more programs, the one or more programs comprising computer instructions, which, when executed by the processor, cause the processor to:
after parameters for consecutive Conditional PSCell Change (CPC) are configured, determine a target sk-counter parameter used in current execution of inter-Secondary Node (inter-SN) CPC;
generate a first security parameter K_{SN} at least based on the target sk-counter parameter; and
access a target PSCell at least based on the first security parameter K_{SN}.

10. The apparatus according to claim 9, wherein the processor is further caused to:
select a first unused sk-counter among a plurality of sk-counter parameters included in the configured parameters as the target sk-counter parameter used in the current execution of inter-SN CPC.

11. The apparatus according to claim 9, wherein the configured parameters comprise a plurality of sk-counter parameters corresponding to the target PSCell.

12. The apparatus according to claim 9, wherein the processor is further caused to:
retain configuration of candidate PSCells other than the target PSCell following accessing the target PSCell.

13. The apparatus according to claim 9, wherein the processor is further caused to:
report a number associated with the first security parameter K_{SN} when accessing the target PSCell.

14. The apparatus according to claim 9, wherein the processor is further caused to:
derive a security parameter based on the first security parameter K_{SN}; and
access the target PSCell based on the derived security parameter.
